(19) United States
(12) Patent Application Publication
(10) Pub. No.: US 2025/0014135 A1
(43) Pub. Date: Jan. 9, 2025

(54) METHOD OF PROVIDING TRAVEL SCHEDULE ASSOCIATED WITH AN AIRLINE SCHEDULE

(71) Applicant: THEFLYTOUR LTD., Seoul (KR)

(72) Inventor: Hyeong Seob LEE, Namyangju-si, Gyeonggi-do (KR)

(73) Assignee: THEFLYTOUR LTD., Seoul (KR)

(21) Appl. No.: 18/708,714

(22) PCT Filed: Nov. 10, 2022
(86) PCT No.: PCT/KR2022/017649

§ 371 Date: May 9, 2024

(30) Foreign Application Priority Data
Nov. 10, 2021 (KR) 10-2021-0153974

(51) Int. Cl. G06Q 50/40

(52) U.S. Cl. CPC G06Q 50/40

(57) ABSTRACT

A method of providing travel schedules associated with airline schedule is disclosed. The method enables the reservation of accommodation taking into account gaps or additions in travel schedules that may occur due to time differences by providing a method for providing a travel schedule associated with an air itinerary. The method also enables the anticipation of changes in travel schedules by receiving alarm information related to flight schedules and providing it to travelers, thereby allowing for the addition or return of accommodation schedules that may occur due to changes in flight schedules. A system for implementing the method is also disclosed.

### TECHNICAL FIELD

The present invention relates to a method of providing travel schedule information, and more particularly, to a method of providing a travel schedule associated with an airline schedule to enable convenient confirmation of travel schedule information when traveling to foreign countries.

### BACKGROUND ART

While long-distance transportation has become more accessible, air travel often still relies on the schedules of major airlines. Aircraft are frequently affected by weather conditions, and their schedules are subject to changes due to factors such as weather disruptions and coordination with other flights for takeoff and landing slots.

Air travel is a popular means of transportation for overseas trips due to its speed. However, airline schedules can be significantly impacted by time zone differences. Crossing longitudinal lines can result in time differences, particularly if a flight is the last or first one on a given date.

Airline schedules, in the context of time zone differences to other countries, greatly influence the reservation of accommodations and local travel plans. While guided tours arranged by travel agencies offer the convenience of following a schedule without the need for individual planning, they impose constraints on travelers who prefer a more flexible itinerary.

On the other hand, independent travel allows individuals to plan their own itineraries and freely move around using local transportation. However, it comes with the inconvenience of booking flights and accommodations independently. Particularly for overseas travel, where airline schedules and time zone differences are factors, there is a high possibility of errors in accommodation reservations.

Furthermore, in the event of airline schedule changes, travelers may need to add or modify accommodation reservations, which can be a cumbersome task, potentially resulting in inconvenience up to the departure time of the flight.

Additionally, when reservations for travel tours, visits to major tourist attractions, or local experience activities are required, it is not easy to schedule and coordinate them independently without the assistance of professional guides.

In addition, if a travel destination tour program, a major tourist destination visit, or a local experience activity must be booked, it is not easy to designate and adjust a schedule to free travel without the assistance of a special guide.

### PRIOR ART DOCUMENTS

### Patent Documents

(Patent Document 1) KR 1020160138828 A
(Patent Document 2) KR 1020170043834 A

### DISCLOSURE

### Technical Problem

The objective of the present invention is to provide a method of providing a travel schedule associated with airline schedule.

Another objective of the present invention is to receive alarm information related to airline schedules and provide it to travelers, thereby enabling the addition or cancellation of accommodation schedules due to changes in airline schedule.

The objectives of the present invention are not limited to those mentioned above, and other objectives not mentioned herein will be clearly understood by those skilled in the art from the following description, which reflects the general knowledge in the technical field to which the present invention pertains.

### Technical Solution

The method of providing a travel schedule associated with an airline schedule according to one aspect of the present invention for solving the above technical problem includes: a step of receiving travel departure date information and travel arrival date information from a traveler through a data transmission/reception unit of a service server; a step of transmitting at least one of the travel departure date information to at least one airline server through the data transmission/reception unit by an airline management unit of the service server; a step of transmitting flight information received from at least one of the airline servers through the data transmission/reception unit to the traveler by an airline schedule management unit of the service server, and transmitting selected boarding information from the traveler to the airline server to which the flight information is transmitted; a step of calculating accommodation day count information of the traveler from the boarding information by a travel schedule management unit of the service server; a step of transmitting the accommodation day count information to at least one accommodation reservation server through the data transmission/reception unit by an accommodation information management unit of the service server; a step of transmitting accommodation schedule information received from at least one accommodation reservation server through the data transmission/reception unit to the traveler by an accommodation schedule management unit of the service server, and transmitting selected accommodation information from the traveler, matching the accommodation schedule information to the accommodation information, to the accommodation reservation server to which the accommodation schedule information is transmitted; and a step of transmitting flight information and accommodation information to the traveler through the data transmission/reception unit by the travel schedule management unit.

Wherein, if the airline schedule management unit receives schedule adjustment information for the boarding information from the airline server to which the flight information is transmitted through the data transmission/reception unit, the method may further include a step of transmitting the schedule adjustment information to the traveler; a step of calculating updated accommodation day count information from the schedule adjustment information by the travel schedule management unit; a step of comparing the updated accommodation day count information with the accommodation day count information received through the data transmission/reception unit by the accommodation schedule management unit, calculating accommodation addition information or accommodation reduction information, transmitting the accommodation addition information corresponding to the accommodation addition request information or the accommodation reduction information corresponding to the accommodation reduction request information from the traveler to at least one accommodation reservation server, and receiving the accommodation renewal information from at least one accommodation reservation server, and transmitting the accommodation renewal information to the traveler by the accommodation schedule management unit.

Wherein, the flight information may include one or more pieces of information selected from the information regarding the departure date of the aircraft, departure time, stopovers, destination, time difference from the departure location, and the location of the arrival airport.

Wherein, the accommodation day count information may further include one or more pieces of information selected from the location of the accommodation, the distance from the arrival airport to the accommodation, and the mode of transportation from the arrival airport to the accommodation.

Wherein, the selected accommodation information may be equipped to be transmitted to at least one accommodation reservation server.

Wherein, the experience schedule management unit of the service server may further include a step of extracting experience program schedule information from local experience travel information received from at least one third-party experience program management server through the data transmission/reception unit; a step of comparing the experience program schedule information with the accommodation schedule information, calculating a schedule gap information between the experience end time included in the experience program schedule information and the check-out time included in the accommodation schedule information or the departure time included in the flight information, and transmitting the calculated schedule gap information to the traveler.

Wherein, through the data transmission/reception unit, receiving at least one experience program confirmation information among one or more experience program schedule information from the traveler;

The experience schedule management unit may further include transmitting the experience program confirmation information to one of the third-party experience program management servers through the data transmission/reception unit matching the experience program confirmation information with the experience program schedule information.

According to another aspect of the present invention, the system for making accommodation reservations associated with an airline schedule includes: a data transmission/reception unit equipped for wired or wireless data transmission/reception between a traveler, airline servers, or accommodation reservation servers; an airline management unit equipped to transmit at least one travel departure date information to at least one airline server through the data transmission/reception unit; an airline schedule management unit equipped to transmit flight information received from at least one airline server to the traveler and transmit selected boarding information from the traveler to the airline server to which the flight information is transmitted; a travel schedule management unit of the service server equipped to calculate accommodation day count information of the traveler from the boarding information or transmit flight information and accommodation information to the traveler through the data transmission/reception unit; an accommodation information management unit equipped to transmit the accommodation day count information to at least one accommodation reservation server through the data transmission/reception unit; and an accommodation schedule management unit equipped to transmit accommodation schedule information received from at least one accommodation reservation server to the traveler, transmit selected accommodation information from the traveler, matching the selected accommodation information to the accommodation schedule information, to the accommodation reservation server to which the accommodation schedule information is transmitted.

### Advantageous Effects

The present invention enables the reservation of accommodation taking into account gaps or additions in travel schedules that may occur due to time differences by providing a method for providing a travel schedule associated with an air itinerary.

The present invention enables the anticipation of changes in travel schedules by receiving alarm information related to flight schedules and providing it to travelers, thereby allowing for the addition or return of accommodation schedules that may occur due to changes in flight schedules.

The effects according to the embodiments of the present invention are not limited by the contents exemplified above, and other various effects are included in the present specification.

### DESCRIPTION OF DRAWINGS

FIG. 1 depicts a system block diagram of a service server for providing a travel schedule associated with airline schedule according to an embodiment of the present invention.

FIG. 2 illustrates a flowchart of a method of providing a travel schedule associated with airline schedule according to an embodiment of the present invention.

FIG. 3 represents a system diagram of a accommodation reservation system associated with airline schedule according to the present invention.

### MODE OF THE INVENTION

The purpose and effects of the invention, as well as the technical configurations for achieving them, will become clear when referring to the detailed embodiments provided with the accompanying drawings. In explaining the invention, specific descriptions of functions or configurations may unnecessarily obscure the essence of the invention, in which case, such detailed explanations will be omitted. The terms used are defined considering the scope of the invention, which may vary according to the intentions or conventions of users or operators.

However, the invention can be implemented in various different forms beyond the disclosed embodiments. The disclosed embodiments are provided to ensure complete disclosure of the invention and to inform those skilled in the art of the scope of the invention, defined by the claims. Therefore, this definition should be based on the content throughout the specification.

Throughout the specification, when a part is described as “including” or “comprising” certain components, this does not exclude the presence of additional components but rather means that other components can also be included. Also, terms such as “ . . . unit,” “ . . . portion,” or “ . . . module” in the specification refer to units that perform one or more functions or operations, which can be implemented by hardware, software, or a combination thereof.

In the embodiments of the invention, each component, functional block, or means may be composed of one or more sub-components, and the electrical, electronic, or mechanical functions performed by each component may be implemented by various known components or mechanical elements, such as electronic circuits, integrated circuits, ASICs (Application Specific Integrated Circuits), and the like, which may be implemented separately or integrated into one or more units.

Furthermore, combinations of each block of the attached block diagrams and steps of the flowcharts may be performed by computer program instructions. These computer program instructions may be loaded onto processors of general-purpose computers, special-purpose computers, portable laptop computers, mobile devices such as smartphones, online game service provider servers, or other programmable data processing apparatus, thereby generating means for performing the functions described in each block of the block diagrams or flowcharts below. These computer program instructions may also be stored in a memory or computer-readable memory accessible to a computer device or other programmable data processing apparatus, such that the instructions, when executed by a computer device or other programmable data processing apparatus, cause a series of operational steps to be performed on the computer device or other programmable data processing apparatus, thereby providing steps for executing the functions described in each block of the block diagrams and flowcharts.

Moreover, each block or step may represent one or more executable instructions for performing specific logical functions. Note also that in some alternative embodiments, the functions mentioned in the blocks or steps may occur out of order. For example, two blocks or steps shown in succession may, in fact, be executed substantially concurrently, or the blocks or steps may sometimes be executed in the reverse order, depending on the functionality involved.

In the embodiments of the invention, the term “user device” refers to any computing means capable of collecting, reading, processing, manipulating, storing, and displaying data, including but not limited to desktop computers, laptop computers, smartphones, PDAs, mobile phones, game consoles, and the like. Particularly, in the embodiments of the invention, the user device can execute software written in decipherable code and is capable of displaying it to and delivering it to the user. Additionally, it may store software as needed and read it with data from external sources.

Furthermore, in the embodiments of the invention, the terminal may include not only data processing functions but also input, output, and storage functions. For this purpose, various elements such as CPU, motherboard, graphics card, hard disk, sound card, speaker, keyboard, mouse, monitor, USB, communication modem, as well as wireless smartphone terminals including CPU, motherboard, graphics chip, memory chip, sound engine, speaker, touchpad, external connection ports like USB, communication antennas, and communication modems capable of implementing various network means such as wired internet, wireless internet, infrared communication, Bluetooth, WCDMA, Wibro, WiFi, LTE, LTE-A, and 5G wireless networks may be included. These various elements may function alone or together, or some parts of various elements may be combined to implement one or more functions. The devices or parts thereof represented by one or more blocks in the drawings or detailed descriptions in the embodiments of the invention may represent one or more functions implemented by the various elements mentioned above, either alone or in combination, and may also include computer-readable media available on computer devices or other programmable data processing devices, allowing computer devices or other programmable data processing devices to execute instructions to perform the functions described in each block or step of the block diagrams.

Meanwhile, in an embodiment of the present invention, a traveler may refer to a traveler device, and the traveler device and a service server may have communication capabilities. To implement communication capabilities, various network means such as wired internet, wireless internet, infrared communication, Bluetooth, WCDMA, WiBro, WiFi, LTE, LTE-A, and 5G wireless communication networks may be provided.

Hereinafter, the present invention provides a method of providing travel schedules associated with airline schedules according to an embodiment of the present invention, with reference to the attached drawings.

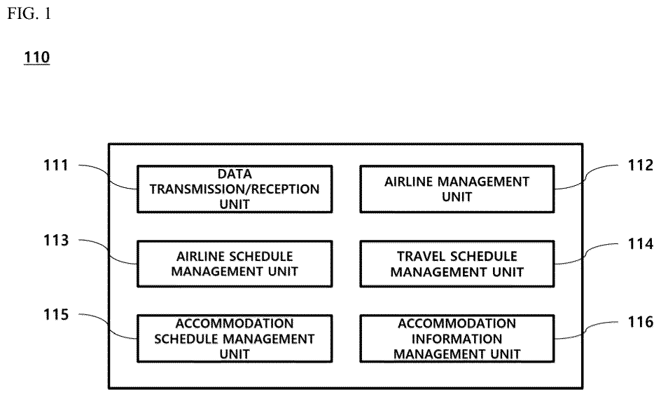

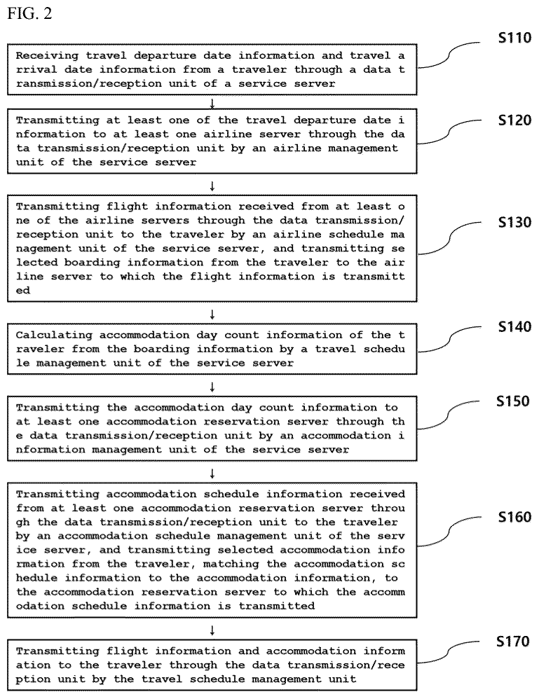

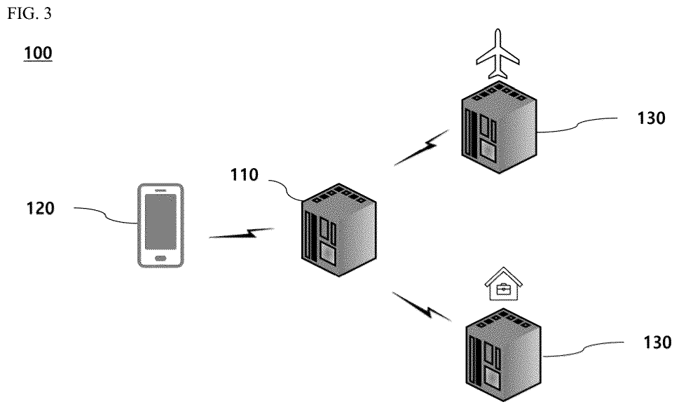

FIG. 1 is a system block diagram of a service server for providing a method of providing travel schedules associated with airline schedules according to an embodiment of the present invention, FIG. 2 is a flowchart of a method of providing travel schedules associated with airline schedules according to an embodiment of the present invention, and FIG. 3 is a system diagram of a accommodation reservation provision system associated with airline schedules according to an embodiment of the present invention.

The service server for providing a method of providing travel schedules associated with airline schedules according to an embodiment of the present invention includes a data transmission/reception unit, an airline management unit, an airline schedule management unit, a travel schedule management unit, a accommodation schedule management unit, and a accommodation information management unit.

In the present invention, the data transmission/reception unit may be equipped to enable wired or wireless data transmission and reception with an airline server or a accommodation reservation server.

Next, the airline management unit may be equipped to transmit travel departure schedule information to at least one airline server via the data transmission/reception unit.

Next, the airline schedule management unit may be equipped to transmit airline flight information received from at least one airline server to travelers via the data transmission/reception unit, and to transmit selected boarding information from travelers to the airline server transmitting the airline flight information.

Next, the travel schedule management unit may be equipped to calculate traveler's accommodation day count information from boarding information or to transmit airline flight information and accommodation information to travelers via the data transmission/reception unit.

Next, the accommodation information management unit may be equipped to transmit accommodation day count information to at least one accommodation reservation server via the data transmission/reception unit.

Next, the accommodation schedule management unit may be equipped to transmit received accommodation schedule information from at least one accommodation reservation server to travelers via the data transmission/reception unit, and to transmit selected accommodation information from travelers to the accommodation reservation server transmitting the accommodation schedule information.

Hereinafter, the method of providing travel schedules associated with airline schedules according to an embodiment of the present invention will be described in detail with reference to FIG. 2.

The method of providing travel schedules associated with airline schedules according to an embodiment of the present invention includes a step of receiving travel departure date information and travel arrival date information from travelers via the data transmission/reception unit of the service server (S110).

For example, travelers typically plan a rough itinerary and arrange travel plans, and it can be expected that travel abroad involves using airplanes for transportation. Here, travel departure date information may include departure date, departure and destination information.

At this time, travel departure date information and travel arrival date information may refer to travel itineraries departing from and returning to the traveler's home country. For example, a traveler may depart from Korea on January 1st, travel to Bali, and return to Korea on January 5th. Travelers can send information corresponding to the start and end dates of the trip to the service server using user devices such as smartphones, tablets, or desktop computers, and the service server can receive, store, process, and utilize this information.

Next, the airline management unit of the service server includes a step of transmitting travel departure date information and/or travel arrival date information to at least one airline server via the data transmission/reception unit (S120).

The airline management unit may transmit the previously received travel departure date information to the airline server and store and manage it. In this case, the airline server may include servers operated directly by airline companies, as well as servers operated by online-connected airline reservation service providers or platform servers equipped for airline reservation.

The travel departure date information is based on the time in the departing country and can be categorized as preceding, current, or following days based on midnight. Additionally, this step may be equipped to transmit departure date information for one-way travel ticket reservations, but is not limited to, and may include arrival date information when departing from and returning to the home country.

Furthermore, travel departure date information may refer to the initial departure date, or it may refer to the date of departure to another destination from the final destination, and this can be indicated based on the initial departing country or based on the local time of the destination.

For example, if departing from Korea on January 1st, traveling to Bali, and then traveling to Vietnam on January 5th, the travel departure date information may correspond to January 1st and January 5th, respectively.

Travel arrival date information is distinct from the travel departure date and refers to returning to the home country from the final destination. This step may further include the airline management unit transmitting travel arrival date information to at least one airline server via the data transmission/reception unit.

Next, the airline schedule management unit of the service server includes a step of transmitting airline flight information received from at least one airline server to travelers via the data transmission/reception unit, and transmitting selected boarding information from travelers to the airline server transmitting the airline flight information (S130).

The airline server transmits airline flight information containing airline schedule information of the aircraft in response to requests from the service server, and the airline schedule management unit of the receiving service server then transmits the received airline flight information to the user. The airline flight information may specifically include the departure date, departure time, layovers, destination, time difference between departure and arrival airports, and airport location.

Moreover, the airline server transmits airline flight information containing airline schedule information of the aircraft in response to requests from the service server, and the airline schedule management unit of the receiving service server then transmits the received airline flight information to the user. The airline flight information may specifically include the arrival date, arrival time, layovers, departure and arrival airport time differences, and airport location.

By transmitting boarding information related to the desired boarding of a flight, corresponding to the airline flight information, to the airline server to which the boarding information was transmitted, the schedule for boarding the aircraft can be confirmed. For example, if a traveler decides to visit Bali on January 1st at 3 p.m. using a direct flight from airline A among A, B, and C airlines, the boarding information may include the departure date of January 1st, departure time of 3 p.m., no layovers, a time difference of 1 hour from Incheon International Airport to the departure and arrival airport, with the arrival airport being Bali International Airport located in Denpasar, Southern Bali, approximately 15 kilometers south of Denpasar.

With regard to the travel arrival date information, boarding information can be generated. As previously described, flight information for returning from another country to one's home country can be obtained, and by transmitting boarding information corresponding to the selected flight for which the traveler wishes to board to the airline server to which the flight information was transmitted, the schedule for boarding the aircraft can be confirmed. For example, if a traveler decides to return to Incheon International Airport on January 4th at 23:00 using a direct flight from airline B among A, B, and D airlines, the boarding information may include the departure date of January 4th, departure time of 23:00, no layovers, and a time difference of 1 hour between Incheon International Airport and Bali International Airport.

The travel schedule management unit of the service server includes a step of deriving the traveler's accommodation day count information from the boarding information (S140).

For example, the travel schedule management unit can count that there is a 1-hour time difference based on the boarding information obtained in the previous step and consider approximately 7-8 hours of flight time, arriving in Korea at 8:00 a.m. on January 5th. If the departure from Bali is at 7:00 a.m. on January 5th, arrival in Korea may occur at 5:00 p.m. on January 5th, considering the flight time and time difference. Even if there is a one-day difference in the local departure schedule, considering the flight time and time difference, arrival on the same date may occur.

If all travel arrival date information is entered as January 5th, the flight information for returning to the home country may include flights departing on January 4th or January 5th. Depending on the selected boarding information, the local accommodation schedule cannot be calculated based solely on the departure date and arrival date information.

Therefore, the travel schedule management unit can derive accommodation day count information by utilizing the departure date, departure time, and time difference between the departure and arrival airports included in the travel arrival date information and boarding information.

In cases where the departure date precedes the travel arrival date by one day, for example, when traveling from January 1st to January 5th, a travel period of 4 days can be calculated, but there may be cases where actual accommodation is required for only 3 days. If the departure from Bali is on the 4th, accommodation should be reserved for only 3 days, but if the departure is on the 5th, it is preferable to reserve accommodation for 4 days. Therefore, by utilizing the departure date, departure time, and time difference between the departure and arrival airports included in the travel arrival date information and boarding information, accommodation day count information can be calculated to allow reservation for only the days when actual accommodation is needed.

Another example is the time difference of approximately 16 hours between Korea and Vancouver, with an average flight time of 10 hours. If departing at 6:00 p.m. on January 1st, arrival at Vancouver Airport would be around 12:00 p.m., so accommodation would need to be booked starting from January 1st. On the other hand, if departing at 10:00 p.m. on January 1st, arrival the next day around 4:00 a.m. would mean accommodation should be booked starting from January 2nd. Therefore, accommodation day count information can be calculated with January 2nd designated as the start date. The accommodation day count information can automatically calculate the dates when accommodation is needed, considering the time difference, thus enhancing traveler convenience.

The accommodation information management unit of the service server includes a step of transmitting the accommodation day count information to at least one accommodation reservation server via the data transmission/reception unit (S150).

The aforementioned accommodation reservation server can be understood to include both a service server operated by hotels or other accommodation facilities and a platform server that provides reservation information for multiple accommodation facilities. The accommodation day count information can be transmitted to the accommodation reservation server to be used for confirming information on available accommodation facilities throughout the entire travel itinerary.

The accommodation schedule management unit of the service server includes a step of transmitting accommodation schedule information received from at least one accommodation reservation server via the data transmission/reception unit to the traveler, and the traveler then transmits selected accommodation information to the accommodation reservation server that sent the matching accommodation schedule information (S160).

Travelers can review the accommodation schedule information, specify their desired accommodation, input the duration of stay, generate accommodation information, and proceed with accommodation reservations by transmitting this information to the service server. For example, if a traveler wishes to reserve a 3-night stay from January 1st to January 3rd, the accommodation schedule information, including such details, is automatically sent to the traveler by the accommodation schedule management unit. After reviewing the accommodation schedule information, the traveler selects a suitable accommodation and transmits it to the service server, which then sends the selected accommodation information and matching accommodation schedule information to the accommodation reservation server, thus initiating the accommodation booking process.

The accommodation schedule information can be integrated with local experience program activities, allowing travelers to select and confirm suitable experience programs.

According to an embodiment of the invention, the experience schedule management unit of the service server includes a step of extracting experience program schedule information from at least one third-party experience program management server based on local experience travel information received via the data transmission/reception unit, comparing the extracted experience program schedule information with the accommodation schedule information, calculating the schedule gap information between the experience end time included in the experience program schedule information and the check-out time included in the accommodation schedule information, or the departure time included in the flight information, and transmitting the calculated schedule gap information to the traveler.

If a traveler wishes to engage in experience activities after the check-out time, the schedule gap information, calculated based on the difference between the departure time in the flight information and the experience end time, can provide a basis for the traveler's decision on whether to proceed with the experience program reservation, thereby increasing travel convenience.

Alternatively, by calculating the schedule gap information based on the difference between the departure time in the flight information and the experience end time, travelers can make informed decisions about selecting post-check-out experience programs, thus saving effort in rationalizing travel time.

For example, assuming a check-out time of 3:00 p.m. local time on January 3rd and considering using the hotel's swimming facilities, it would be desirable for the experience program to end before 3:00 p.m. By comparing the check-out time with the start time of the experience program according to the travel schedule providing method of the present invention, it is possible to calculate how long the experience can be enjoyed. Alternatively, if there is sufficient time after the check-out time until the departure time included in the flight information, comparing the departure time with the end time of the experience program can be provided to travelers to enable them to use their travel time more effectively.

Accordingly, in an embodiment of the present invention, after travelers confirm the experience program schedule information and decide on a specific program, they can conveniently proceed with the reservation.

For this purpose, a method of providing a travel schedule according to an embodiment of the present invention may further include a step of receiving, via the data transmission/reception unit, confirmation information for one of the experience programs from the traveler, and a step of the experience schedule management unit transmitting the confirmation information for the experience program, which matches the confirmation information for the experience program received via the data transmission/reception unit, to one of the third-party experience program management servers through which the matching experience program schedule information was transmitted.

Thus, after travelers review the previously calculated schedule gap information and finalize their choice of experience program, they can transmit this information to the service server. The service server then forwards the information regarding the selected experience program to the appropriate third-party experience program management server for booking. The service server may also be equipped to transmit payment information to the third-party experience program management server. For example, if there is approximately a 5-hour difference between the departure time included in the flight information and the end time of a museum visit included in the experience program information, the traveler can transmit the museum visit program as confirmation information to the service server. Upon receiving this information, the experience schedule management unit of the service server can transmit the confirmation information for the museum visit program to the third-party experience program management server that provides the museum visit program, thereby confirming the reservation.

Next, the travel schedule management unit includes a step of transmitting flight information and accommodation information to the traveler via the data transmission/reception unit (S170).

The travel schedule management unit transmits flight information and accommodation information to the traveler via the data transmission/reception unit, providing information such as flight tickets, accommodation facilities, and duration of stay.

Moreover, if the airline schedule management unit receives schedule adjustment information for boarding information from the airline server via the data transmission/reception unit, the method may include a step of transmitting the schedule adjustment information to the traveler, a step of the travel schedule management unit calculating updated accommodation day count information from the schedule adjustment information, a step of the accommodation schedule management unit comparing the updated accommodation day count information with the accommodation day count information and generating accommodation addition information or accommodation reduction information, and a step of the accommodation schedule management unit transmitting the generated information to the traveler via the data transmission/reception unit and receiving accommodation renewal information corresponding to accommodation addition information or accommodation reduction information from at least one accommodation reservation server, and a step of the accommodation schedule management unit transmitting the received accommodation renewal information to the traveler via the data transmission/reception unit may be further included.

In other words, flight information is stored on the airline server upon completion of flight reservations. If there are changes to the schedule due to weather conditions or adjustments to the airline schedule, the airline server transmits schedule adjustment information including the updated information such as the departure date and time of the flight to the service server. The airline schedule management unit of the service server receives this information via the data transmission/reception unit and then forwards it to the traveler.

This allows travelers to confirm whether the travel itinerary aligns with the travel duration calculated from the departure and arrival travel dates they have set.

Additionally, the travel schedule management unit of the service server calculates updated accommodation day count information from the schedule adjustment information, considering time zone differences and flight durations, and sends accommodation addition information or accommodation reduction information to the traveler. The traveler then receives corresponding accommodation addition request information or accommodation reduction request information and sends it to multiple accommodation reservation servers. From at least one of the accommodation reservation servers, the traveler receives accommodation renewal information corresponding to the accommodation addition request information or accommodation reduction request information, which is then transmitted to the traveler, allowing for the progression of new accommodation reservations.

Without requiring separate confirmation or calculations regarding whether additional or reduced accommodation is needed due to changes in airline schedules, the travel schedule providing method according to an embodiment of the present invention automatically provides information on changes to accommodation reservation schedules. This greatly enhances the convenience of booking accommodation for travelers.

The accommodation renewal information may include new accommodation facilities instead of the existing ones where the traveler is staying, and it may be sent to multiple accommodation reservation servers. For example, the traveler may stay at Hotel Z until the schedule is updated, then continue the stay at Hotel Y.

For instance, if the examination of schedule adjustment information reveals that there is little difference from the existing departure time included in the flight information, indicating a schedule with a short waiting time before departure, selecting accommodation near the airport can reduce variables associated with traveling to the airport. Conversely, if there is a significant difference from the existing departure time, it may be possible to select accommodation near tourist attractions to explore areas further from the airport.

Although the embodiments of the present invention have been described with reference to the attached drawings. However, those skilled in the art to which the present invention pertains will understand that the present invention can be implemented in other specific forms without changing the technical concept or essential features of the invention. Therefore, the embodiments described above should be understood as exemplary in all respects, and not restrictive.

1. A method of providing a travel schedule associated with an airline schedule, characterized by comprising the following steps:
receiving travel departure date information and travel arrival date information from a traveler through a data transmission/reception unit of a service server;
transmitting the travel departure date information to at least one airline server through the data transmission/reception unit by an airline management unit of the service server;
transmitting flight information received from at least one of the airline servers through the data transmission/reception unit to the traveler by an airline schedule management unit of the service server, and transmitting selected boarding information from the traveler to the airline server to which the flight information is transmitted;
calculating accommodation day count information of the traveler from the boarding information by a travel schedule management unit of the service server;
transmitting the accommodation day count information to at least one accommodation reservation server through the data transmission/reception unit by an accommodation information management unit of the service server;
transmitting accommodation schedule information received from at least one accommodation reservation server through the data transmission/reception unit to the traveler by an accommodation schedule management unit of the service server, and transmitting selected accommodation information from the traveler, matching the accommodation information to the accommodation schedule information, to the accommodation reservation server to which the accommodation schedule information is transmitted; and
transmitting flight information and accommodation information to the traveler through the data transmission/reception unit by the travel schedule management unit.

2. In the method according to claim 1,
if the airline schedule management unit receives schedule adjustment information for the boarding information from the airline server to which the flight information is transmitted through the data transmission/reception unit, the method further includes a step of transmitting the schedule adjustment information to the traveler;
a step of calculating updated accommodation day count information from the schedule adjustment information by the travel schedule management unit;
a step of comparing the updated accommodation day count information with the accommodation day count information received through the data transmission/reception unit by the accommodation schedule management unit, calculating accommodation addition information or accommodation reduction information, transmitting the accommodation addition information corresponding to the accommodation addition request information or the accommodation reduction information corresponding to the accommodation reduction request information from the traveler to at least one accommodation reservation server, and receiving the accommodation renewal information from at least one accommodation reservation server, and transmitting the accommodation renewal information to the traveler by the accommodation schedule management unit.

3. In the method according to claim 1,
wherein the flight information includes one or more pieces of information selected from the information regarding the departure date of the aircraft, departure time, stopovers, destination, time difference from the departure location, and the location of the arrival airport, associated with an airline schedule.

4. In the method according to claim 1,
wherein the accommodation day count information further includes one or more pieces of information selected from the location of the accommodation, the distance from the arrival airport to the accommodation, and the mode of transportation from the arrival airport to the accommodation, associated with an airline schedule.

5. In the method according to claim 1,
wherein the selected accommodation information is equipped to be transmitted to at least one accommodation reservation server, associated with an airline schedule.

6. In the method according to claim 1,
wherein the experience schedule management unit of the service server further includes a step of extracting experience program schedule information from local experience travel information received from at least one third-party experience program management server through the data transmission/reception unit; a step of comparing the experience program schedule information with the accommodation schedule information, calculating a schedule gap information between the experience end time included in the experience program schedule information and the check-out time included in the accommodation schedule information or the departure time included in the flight information, and transmitting the calculated schedule gap information to the traveler, associated with a travel schedule.

7. In the method according to claim 6,
wherein through the data transmission/reception unit, receiving at least one experience program confirmation information among one or more experience program schedule information from the traveler; transmitting the experience program confirmation information to one of the third-party experience program management servers through the data transmission/reception unit matching the experience program confirmation information with the experience program schedule information, associated with a travel schedule.

8. In the method according to claim 1,
the airline schedule management unit transmits the received schedule correction information from the airline server, which transmitted the airline flight information via the data transmission/reception unit, to the traveler;
the travel schedule management unit calculates updated accommodation day count information from the received schedule correction information;
the accommodation schedule management unit compares the updated accommodation day count information with the accommodation day count information and generates accommodation addition information or accommodation reduction information to transmit to the traveler, and accommodation schedule management unit receives accommodation renewal information corresponding to the accommodation addition information or accommodation reduction information from at least one accommodation reservation server and transmits the received accommodation renewal information to the traveler via the data transmission/reception unit; and
the experiential schedule management unit extracts experience program schedule information from at least one third-party experience program management server based on local experience travel information received via the data transmission/reception unit, compares the extracted experience program schedule information with the accommodation schedule information, calculates the schedule gap information between the experience end time included in the experience program schedule information and the check-out time included in the accommodation schedule information, or the departure time included in the flight information, and transmits the calculated schedule gap information to the traveler;
receives confirmation information for one of the experience programs from the traveler via the data transmission/reception unit, and transmits the confirmation information for the experience program matching the confirmation information received via the data transmission/reception unit to one of the third-party experience program management servers through which the matching experience program schedule information was transmitted;
and the airline flight information includes schedule correction information received from the airline server, which transmitted the airline flight information, based on weather deterioration or flight schedule adjustment with other aircraft, including changes in the departure date and time, and the airline schedule management unit further includes a step of transmitting the received schedule correction information to the traveler via the data transmission/reception unit.

9. An accommodation reservation system associated with airline schedules, comprising:
a data transmission/reception unit capable of wired or wireless data transmission/reception with travelers, airline servers, or accommodation reservation servers;
an airline management unit equipped to transmit at least one travel departure schedule information to at least one airline server through the data transmission/reception unit;
an airline schedule management unit equipped to transmit flight information received from at least one airline server through the data transmission/reception unit to travelers, and to transmit selected boarding information from the travelers to the airline server to which the flight information was transmitted;
a travel schedule management unit of the service server equipped to calculate the accommodation day count information of travelers from the boarding information or to transmit flight information and accommodation information to travelers through the data transmission/reception unit;
an accommodation information management unit equipped to transmit the accommodation day count information to at least one accommodation reservation server through the data transmission/reception unit; and
an accommodation schedule management unit equipped to transmit accommodation schedule information received from at least one accommodation reservation server to travelers through the data transmission/reception unit, and to transmit selected accommodation information from the travelers to the accommodation reservation server matching the accommodation information to the accommodation schedule information;
comprising an accommodation reservation system associated with airline schedules.

10. A storage medium storing a program for executing the method according to claim 1.
